(19) United States
(12) Patent Application Publication
(10) Pub. No.: US 2015/0120945 A1
(43) Pub. Date: Apr. 30, 2015

(54) Push Channel Based Creation of Web-Based User Interface Sessions

(71) Applicant: Masoud Aghadavoodi Jolfaei, Walldorf (DE)

(72) Inventor: Masoud Aghadavoodi Jolfaei, Walldorf (DE)

(73) Assignee: SAP AG, Walldorf (DE)

(21) Appl. No.: 14/064,495

(22) Filed: Oct. 28, 2013

(51) Int. Cl. H04L 29/08

(52) U.S. Cl. CPC H04L 67/26; H04L 67/14
USPC 709/228

(57) ABSTRACT

Systems and methods for instantiating new web UI sessions and web UI agents using push channels are disclosed. When a new web UI session is created in an application server in response to a function request from an existing web UI agent, its network address is pushed to the existing web UI agent to create a new web UI agent. The new web UI agent can then be attached to the new web UI session using the address provided to the existing web UI agent. To push the network address to the original web UI agent, a dedicated bi-directional network connection is established between the existing web UI agent and an application push channel session. The new web UI session can push its address to the existing web UI agent through an AMC.

### BACKGROUND

Unless otherwise indicated herein, the approaches described in this section are not prior art to the claims in this application and are not admitted to be prior art by inclusion in this section.

Conventional centralized data management and storage systems use client-server configurations to provide users with UIs for accessing information. A UI agent is usually instantiated in a dedicated application on a network enabled client computer. In addition to handling the generation or rendering of the UI on a display device of the client computer, the UI agent also includes functionality for connecting to the target centralized data management and storage system. For example, the UI agent may handle setting up a dedicated communication connection between the UI agent and the target data management and storage system, and authenticating a user to the data management and storage system. In some systems, setting up the dedicated UI communication connection may include requesting the creation of a corresponding proxy session in the data management and storage system for executing the functions in the data management and storage system requested by the UI agent. The proxy is often referred to herein as a UI session.

Some functions executed by a UI session can result in the creation of additional or alternative UIs in the client computing device, which, in turn, requires the creation of additional UI sessions in the data management and storage system and corresponding UI connections. For example, a master detail report that includes summary or general information about a particular set of data may be displayed in a particular master detail UI on the client computer. The master detail UI may include controls for examining various aspects of the data in more detail. Since the goal of the master detail UI may be to provide a consistently clear, concise, and uncluttered representation of the summary data, it may be undesirable to alter its appearance with additional detail. Thus, to avoid changing the appearance or content of the master detail UI, it is possible to open up new UIs (e.g. open new windows in a graphical user interface (GUI)) to show the data in more detail. Opening an additional UI usually requires the data management and storage system to instantiate an additional UI session, which, in turn, requests that the client computer instantiates a corresponding additional UI agent.

In implementations in which the UI connection between each UI agent-session pair is handled by a dedicated UI application using two-way messaging protocol, creation of additional UI agent-session pairs is straight forward. Once a new UI session is created, the data management and storage system can simply send a request to the dedicated application that a new UI agent be instantiated in the client computer and connected to the newly created UI session with a new UI connection. However, in web based UI applications, it is often not possible instantiate a new UI agent in response to a newly created UI session. Limitations in conventional web based UI applications (e.g., HTML or JAVA script based application executed in a web browser) and communication protocols (e.g., HTTP or HTTPS) do not allow for newly created UI sessions to send an unsolicited request to UI application to instantiate new UI agents.

### SUMMARY

The present disclosure relates to accessing information in a central data source through a web (i.e., the Internet) connection using a web user interface (UI) agent implemented in a web browser. In particular, this disclosure relates to systems and methods for automatically creating additional web UI sessions in an application server, and their associated web UI agents in a web browser, using application push channels (APCs) in an application server.

Embodiments of the present disclosure improve push channel based creation of web-based user interface sessions. One embodiment of the present disclosure includes a method that includes receiving a logon request through a network from a first web user interface (UI) agent. The first web UI agent is instantiated in a web browser executed on client computer and renders a corresponding first UI displayed in the web browser. The method also includes instantiating in response to the logon request, a first web UI session in communication with the first UI agent through a first UI connection established over the network. The first web UI session handles the execution of functions in response to requests from the first web UI agent. Such embodiments also include generating in the first web UI session a first identifier, wherein the first identifier uniquely identifies the first UI connection, the first web UI agent, or the first web UI session, sending the first identifier from the computer system to the first web UI agent in the client computer, receiving, in an application push channel (APC) session instantiated in the computer system, an initiation request comprising the first identifier from the first web UI agent. The APC session then binds the UI connection to a particular AMC in the AMC framework. The AMC framework comprises a messaging protocol for communicating messages between web UI sessions instantiated in the computer system and web UI agents instantiated in the web browser according to one or more AMC definitions. The AMC definitions are handled by the AMC framework. The AMC framework and/or the AMC definitions comprise messaging protocols for exchanging messages using a publish/subscribe paradigm. The AMC definitions and/or the AMC framework comprise network addresses to one or more of the web UI agents instantiated in the web browser.

In one embodiment, the method also includes receiving, in the first web UI session through the first UI connection from the first web UI agent, a request to execute a first function, executing, in the first web session, the first function, wherein the first function causes a second web UI session to be instantiated in the computer system, the second web UI session outputs UI information to be displayed in a second UI displayed in the web browser, generating, in the computer system, a second identifier associated with the second web UI session, and sending a network address for the second web UI session comprising the second identifier to the first web UI session through the AMC framework to the first web UI agent according to at least one of the AMC definitions associated with the first identifier, wherein the first web UI agent causes a second web UI agent to be instantiated in the web browser in communication with the second web UI session through a second UI connection comprising the network address for the second web UI session.

In one embodiment, the method also includes receiving, in the second web UI session through the second UI connection from the second web UI agent through, a request to execute a second function, executing, in the second web UI session, the second function to generate a response, and sending the response to the second from the second web UI session to the second web UI agent through the second UI connection.

In one embodiment, sending the network address for the second web UI session also includes sending instructions that cause the first web UI agent to instantiate the second web UI agent in a new web browser window or in a new web browser tab.

In one embodiment, the first UI connection includes a bi-directional transport control protocol (TCP).

In one embodiment, the AMC definitions include network addresses to one or more of the web UI sessions instantiated in the computer system.

In one embodiment, the method also includes initiating a WebSocket connection between the first web UI agent and the APC session in response to the initiation request.

Another embodiment of the present disclosure includes a non-transitory computer readable medium having instructions that when executed by a computer processor cause the computer processor to be configured for: receiving a logon request through a network from a first web user interface (UI) agent, wherein the first web UI agent is instantiated in a web browser executed on client computer and renders a corresponding first UI displayed in the web browser, instantiating in response to the logon request, a first web UI session in communication with the first UI agent through a first UI connection established over the network, wherein the first web UI session handles the execution of functions in response to requests from the first web UI agent, generating in the first web UI session a first identifier, wherein the first identifier uniquely identifies the first UI connection, the first web UI agent, or the first web UI session, sending the first identifier from the computer system to the first web UI agent in the client computer, receiving, in an APC session instantiated in the computer system, an initiation request comprising the first identifier from the first web UI agent. The APC session then binds the UI connection to a particular AMC in the AMC framework. The AMC framework comprises a messaging protocol for communicating messages between web UI sessions instantiated in the computer system and web UI agents instantiated in the web browser according to one or more AMC definitions. The AMCs and/or the AMC definitions may be handled the AMC framework. The AMC framework and/or the AMC definitions comprise messaging protocols for exchanging messages using a publish/subscribe paradigm. The AMC definitions and/or the AMC framework comprise network addresses to one or more of the web UI agents instantiated in the web browser.

Yet another embodiment of the present disclosure includes a system comprising: a computer processor, and a non-transitory computer readable medium comprising instructions that when executed by the computer processor cause the computer processor to be configure to: receive a logon request through a network from a first web user interface (UI) agent, wherein the first web UI agent is instantiated in a web browser executed on client computer and renders a corresponding first UI displayed in the web browser, instantiate in response to the logon request, a first web UI session in communication with the first UI agent through a first UI connection established over the network, wherein the first web UI session handles the execution of functions in response to requests from the first web UI agent, generate in the first web UI session a first identifier, wherein the first identifier uniquely identifies the first UI connection, the first web UI agent, or the first web UI session, send the first identifier from the computer system to the first web UI agent in the client computer, receive, in an APC session instantiated in the computer system, an initiation request comprising the first identifier from the first web UI agent. The APC session then binds the UI connection to a particular AMC in the AMC framework. The AMC framework comprises a messaging protocol for communicating messages between web UI sessions instantiated in the computer system and web UI agents instantiated in the web browser according to one or more AMC definitions. The AMC definitions are handled by the AMC framework. The AMC framework and/or the AMC definitions comprise messaging protocols for exchanging messages using a publish/subscribe paradigm. The AMC definitions and/or the AMC framework comprise network addresses to one or more of the web UI agents instantiated in the web browser.

The following detailed description and accompanying drawings provide a better understanding of the nature and advantages of the present invention.

### BRIEF DESCRIPTION OF THE DRAWINGS

FIG. 1 illustrates a system for accessing remote data using web-based UI agents instantiated in a web browser.

FIG. 2 illustrates a system with push channels for instantiating additional web UI session according to one embodiment of the present disclosure.

FIG. 3 illustrates an example of a system for creating new web UI sessions and corresponding web UI agents using push channels according to one embodiment of the present disclosure.

FIG. 4 illustrates a dataflow for creating new web UI sessions and corresponding web UI agents using push channels according to one embodiment of the present disclosure.

FIG. 5 is a flowchart of a method according to one embodiment of the present disclosure.

FIG. 6 illustrates an example of a computer system and network that may be used to implement various embodiments of the present disclosure.

### DETAILED DESCRIPTION

Described herein are techniques for push channel based creation of web based user interface sessions. In the following description, for purposes of explanation, numerous examples and specific details are set forth in order to provide a thorough understanding of the present disclosure. It will be evident, however, to one skilled in the art that the present invention as defined by the claims may include some or all of the features in these examples alone or in combination with other features described below, and may further include modifications and equivalents of the features and concepts described herein.

Overview

Embodiments of the present disclosure include systems and methods for improved web based user interfaces for accessing information in centralized data management and storage systems (DMSS). A web based UI agent, referred to herein as a “web UI agent”, may be instantiated in a web browser according to web based UI instructions (e.g., HTML or JAVA) to handle and provide a web UI for accessing information in the DMSS. The web UI agent can send application level requests (e.g., HTTP or HTTPS) using a network protocol (e.g., TCP or TCP/IP) over a network (e.g., an intranet or the Internet) to request a bi-directional connection (e.g., WebSocket) with the DMSS. In response to the request, the DMSS, or an application server therein, can instantiate a corresponding web UI session to execute functions in the DMSS requested by the web UI agent. When the DMSS instantiates the web UI session it can also assign a web UI agent identifier (UID) to the web UI agent. The UID may uniquely identify the corresponding web UI agent, the web UI session, and/or the

The web UI agent may then send a logon request to the DMSS. In one embodiment, when the web UI agent logs into the DMSS, the DMSS may initiate a bi-directional connection between the web UI agent and web UI session that can be bound to one or more AMCs in an AMC framework. The AMC framework may include a number of AMCs for communicating among the UI sessions and other applications instantiated in an application server of the DMSS. To bind a bi-directional connection between the web UI agent and UI session to a particular AMC, the APC session may create an AMC definition that defines the bi-directional connection as a subscriber to the AMC. As such, the AMC can be specified as a publisher to the AMC in the AMC definition. Accordingly, any message sent to a particular AMC can then be automatically forwarded, also referred to herein as being “pushed”, to the bi-directional UI connection, and the corresponding web UI agent, bound to the particular AMC by the AMC framework. In this way, the AMC in combination with the bi-directional UI connection acts as a push channel through which information regarding other web UI sessions can be pushed to web UI agent.

Accordingly, when the web UI session, based on user input or instructions/programming associated with an a function call (e.g., a remote function call received from a web UI agent) creates a new web UI session with a particular address in the DMSS, the new web UI session can send its address (e.g., TCP/IP address) over the AMC to the original web UI agent (e.g., over a WebSocket connection). In response to the receiving the address for the new web UI session, the web UI agent can cause a new web UI agent to be instantiated in the web browser in either a new browser window or in a new tab. The new web UI agent can then be associated with and connected to the new web UI session by a bi-directional connection using the address pushed to the original web UI agent. Once the new web UI agent-session pair is created, the new web UI session may communicate with the new web UI agent (e.g., a screen of data requested by the original web UI session that cause the creation of the new web UI agent) over the new bi-directional connection.

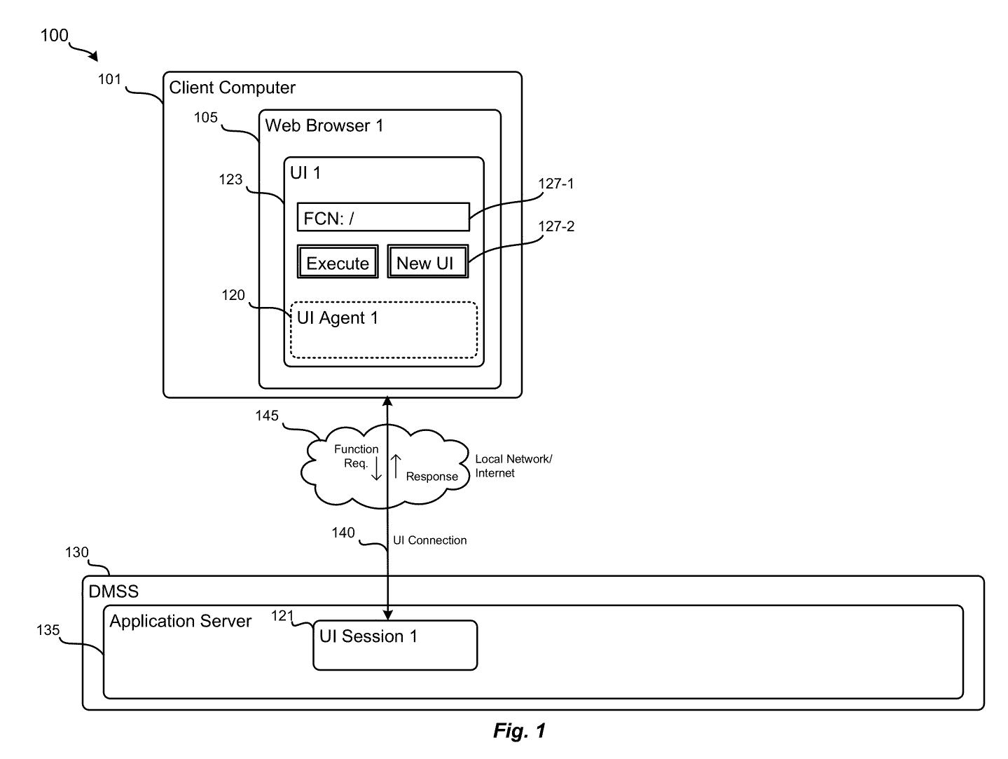

FIG. 1 illustrates a typical system 100 for accessing information in a data management and storage system (DMSS) 130. In such systems, a client computer 101 may instantiate a web UI agent 120 in web browser 105 to display a corresponding UI 123. The web UI agent 120 may connect to the remote DMSS 130 through a UI connection 140 established over network 145 (e.g., an intranet or the Internet) to communicate with a corresponding web UI session 121 instantiated in an application server 135 of the DMSS 130. The UI may include controls 127 for receiving user input, commands, and instructions for requesting the execution of various functions. Accordingly, the web UI agent 120 can send requests to the web UI session 121 to perform various functions on the data in the DMSS 130. In response to the requests, the web UI session 121 may execute the requested functions and return the results to the web UI agent 120. The results of the functions may then be displayed in the UI 123 by the web UI agent 120.

The execution of some functions may require the web UI session 121 to cause additional web UI sessions 121 to be instantiated in the application server 135. However, because there is no mechanism for the newly instantiated web UI sessions 121 to communicate their addresses (e.g., URL) to the web browser 105 or the web UI agent 120, it is not possible to instantiate new corresponding web UI agents 120 in the web browser 105. There would be no way to establish a corresponding UI connection 140 between the newly instantiated web UI sessions 121 and the web UI agents 120 and, therefore, there would be no way to send/receive requests for and responses to functions calls. As such, in systems like system 100, function calls from the original web UI agent 120 to web UI session 121 are configured to limit or disallow functions or commands that result in the original web UI session 121 from creating additional web UI sessions 121 in the application server 135. Various embodiments of the present disclosure address such limitations.

In one specific example, the DMSS 130 may include any number of products or business systems offered by SAP AG. Accordingly, the application server 135 may be implemented as an instance of a SAP™ NetWeaver™ Advanced Business Application Programming (ABAP) engine. The web UI sessions 121 instantiated in the application server 135 may be implemented as instances of SAP WEB GUI sessions, while the web UI agents 120 may be implemented as instances of SAP WEB GUI agents.

System: Setup Phase

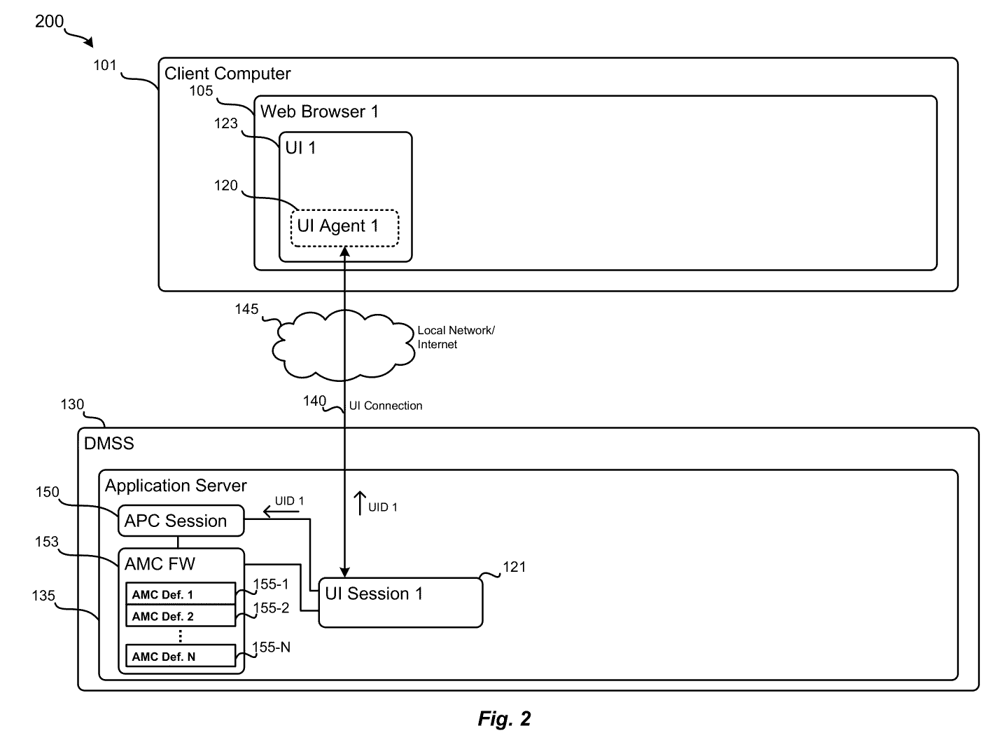

FIG. 2 illustrates system 200 that includes an APC session 150 for facilitating the instantiation of additional web UI sessions in the application server 135 and establishing communication between the additional web UI sessions and corresponding web UI agents in the web browser 105. In particular, FIG. 2 shows system 200 in the step up phase for creating additional web UI sessions using APC session 150, according to various embodiments of the present disclosure. As shown, the system 200 may include a client computer 101 and an application server 135 in a DMSS 130. In one embodiment, the client computer 101 may execute a web browser 105 and display a corresponding web browser window. The web browser may then initiate a web UI agent 120 by navigating to a URL (e.g., http://host:port/webui) associated with the DMSS 130. In one embodiment, navigating to the URL creates a UI connection 140 between the web browser 105 and an application server 135 through the network 145. The connection may include a bi-directional connection (e.g., a WebSocket connection) between the web browser and the application server 135.

To facilitate communication between web UI session 121 and the APC session 150, various embodiments of the present disclosure may use ABAP messaging channels (not shown). The ABAP messaging channels, or more generically, application messaging channels (AMC), include a method of communication between ABAP and non-ABAP programs instantiated in the application server using messages. Messages can be exchanged between any program, including communication among web UI sessions 121 and other applications. While the SAP™ implementations of various components of the system 200 are possible, embodiments of the present disclosure are not limited to the offerings of SAP™. Accordingly, one of ordinary skill in the art will realize system 200 may include various types of client-server based centralized DMSS that utilize application messaging channels (AMCs) for communication among the web UI sessions 121, APC session 150, and other applications in the application server 135.

In one embodiment, navigating to the URL can be accomplished by the execution of a set of computer readable instructions to instantiate the web UI agent 120 in the web browser 105. Accordingly, the set of instructions to instantiate the web UI agent 120 may be embodied as HTML code or JAVA code (e.g., a JAVA script) that can either be preinstalled in the web browser 105 or downloaded and installed on-demand when the web browser 105 navigates to the URL.

In such embodiments, the particular implementation of the instructions to instantiate the web UI agent 120 may be independent of the operating system of the client computer 101. This indifference to the operating system of the client computer 101 is commonly referred to as be system agnostic. System agnosticism can greatly reduce the time, effort, and cost associated with installing and maintaining the web UI agents 120 implemented in large deployments of client computer systems 101. Instead of requiring administrators to handle the installation, maintenance and potential customization of potentially hundreds, if not thousands, of UI agents on individual client computers 101, the web UI agent 120 can be quickly deployed and changed by installing the downloadable instructions for instantiating the web UI agent 120 on the host to which the browser 105 pointed. Accordingly, when the browser 105 contacts the host at the URL, it can download the instructions for instantiating the web UI agent 120 at that time and then follow the instructions to instantiate or update the web UI agent 120.

In one embodiment, once the web UI agent 120 is instantiated, it may establish a dedicated UI connection 140 to connect to and log onto the application server 135. Then, using UI connection 140, the web UI agent 120 may request the application server 135 instantiate a corresponding web UI session 121. The web UI session 121 may handle the execution of functions in the application server 135 or the DMSS 130 in response to remote function calls (RFCs) and other requests and commands from the web UI agent 120. For example, the web UI session 121 may execute functions on one or more data stores 133 in the central DMSS 130 to access information therein. The web UI session 121 may then return the requested information to the web UI agent 120 so that is may be displayed in a corresponding UI in the browser 105.

Once the web UI session 121 is instantiated, it can generate a unique web UI agent identifier (UID) and send it to the web UI agent 120 and the APC session 150. This UID can be used to uniquely identify the web UI agent 120 to other web UI agents 120 that may be instantiated in the client computer 101 and other web UI sessions 121 and applications that may be instantiated in the application server 135. The APC session 150 instantiated in the application server 135 may register the web UI agent 120 and its dedicated UI connection 140 to the corresponding web UI session 121 using the UID.

The APC session 150 may be coupled to an AMC framework 153. The AMC framework 153 may include a number AMCs through which various applications instantiated in the application server 135 may communicate with one another. The AMCs may be instantiated as corresponding AMC definitions 155. The AMC definitions 155 may specify which applications or web UI sessions 121 may publish to a particular AMC, and which applications or web UI sessions 121 subscribe to a particular AMC. The AMC definitions may also include other information, such as what types of messages that may be published on an AMC (e.g., binary, text, structure type x, table type y, etc.).

In one embodiment, registering the web UI agent 120 or its corresponding bi-directional UI connection 140 (e.g., WebSocket) with the APC session 150 may include binding the bi-directional UI connection 140 to a particular AMC or AMC definition 155 using the corresponding UID. Binding the bi-directional UI connection 140 to an AMC may include listing the UI connection 140 as a publisher or subscriber in one or more AMC definitions 155. As such, other applications and web UI session 121 can send information and messages to the associated web UI agent 120 by sending a message and the UID to AMC framework 153.

The AMC framework 153 handles the exchange between AMC subscriber and publishers. The bi-directional UI connection 140 can be a subscriber or publisher to the AMC to which it is bound in the AMC framework 153. The AMC framework 153 may determine on which AMC the information or message should be broadcast based on the UID and AMC definitions 155. For example, the AMC framework 153 may reference the AMC definitions 155 to determine one or more AMC associated with the UID. The AMC framework 153 will then forward any messages or data to the web UI agent 120 associated with the UID through the corresponding AMC and subscribing UI connection 140 according to one or more AMC definitions 155.

The mechanisms and methodology for sending messages to a web UI agent 120 through an AMC framework 153 that administers and handles AMC definitions 155 may be used in various embodiments to facilitate the instantiation of new web UI agents in the browser 105 in response to the web UI session 121 executing functions that create additional new web UI sessions. In some embodiments, an original web UI session 121 may instantiate new web UI sessions to support new UIs (e.g., UIs displayed in new browser windows or tabs) to display alternative or supplementary views of the data displayed in the original UI supported by the original web UI session 121 and rendered by the original web UI agent 120.

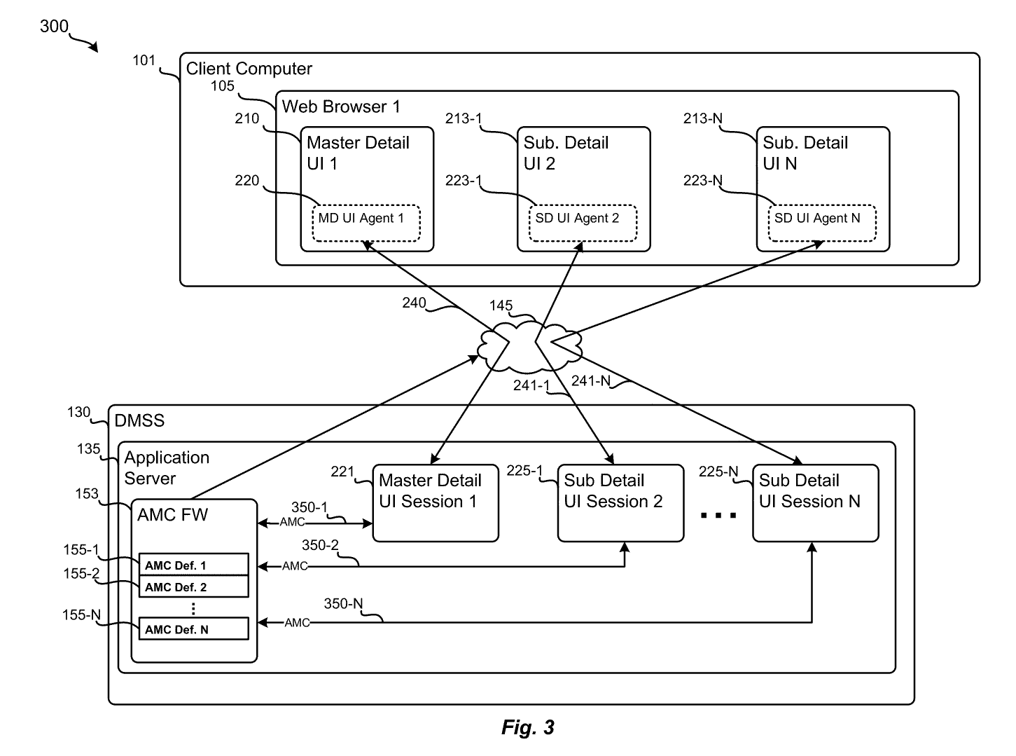

FIG. 3 illustrates system 300 in an example configuration in which N additional web UI sessions 225 have been instantiated by a function executed by the original web UI session 221 in the application server 135. As used herein, N is a natural number. The particular configuration shown may be illustrated in reference to an example use case in which a master detail (MD) UI 210 is displayed in a web browser 105. The MD UI 210 may be rendered by a corresponding MD UI agent 220 instantiated in the browser 105. The information displayed in the MD UI 210 may be provided to the MD UI agent 220 by MD UI session 221 over the corresponding UI connection 240.

The MD UI 210 may include fields and controls for receiving user input or executing programs that control web UI agent 220 to request functions that cause the MD UI session 221 to instantiate subordinate detail (SD) UI sessions 225. For example, in the scenario in which the MD UI 210 shows an overview of some set of data in the DMSS 130, it may be desirable to view additional details or drill down into the data without augmenting or cluttering the layout of the MD UI 210. In such scenarios, it is desirable to open up new SD UIs 213 to show the additional aspects or details of the data represented in the MD UI 210. The MD UI session 221, as a result of executing one or more functions, may instantiate the SD UI sessions 225.

When the MD UI session 221 instantiates, or causes the application server 135 to instantiate, the SD UI sessions 225 it can also generate a unique external web UI session identifier (ESID) for each corresponding SD UI session 225. The MD UI session 221 may send the ESIDs to the SD UI sessions 225 using corresponding AMCs 350 through the AMC framework 153. The SD UI sessions 225 each have a unique network addresses based on or associated with its ESID. The SD UI sessions 225 may then send their corresponding network addresses to the MD UI agent 220 using one of the AMCs 350 and/or through AMC framework 153 based on an AMC definition 155 associated with the UID for the MD UI agent 220. For example, the SD UI sessions 225 may send messages to the MD UI 210 through a WebSocket connection assigned to the MD UI agent 1 220 by sending messages through the AMC framework 153 and the network 145. The MD UI agent 220 may then instantiate one or more SD UI agents 223 to support the display of the subordinate detailed information provided by SD UI sessions 225 in new SD UIs 213.

The new SD UIs 213 may be displayed in new browser windows or new browser tabs in the web browser 105. When SD UI agents 223 are instantiated, they may be attached to the network address for the corresponding SD UI sessions 225 in the application server 135, so that a corresponding UI connections 241 may be established through the network 145. Once the corresponding UI connections 241 between the corresponding SD UI agent-session pairs are established through the network 145, requests for and responses to functions can be exchanged to display information in the corresponding SD UIs 213 based on information stored in the DMSS 130.

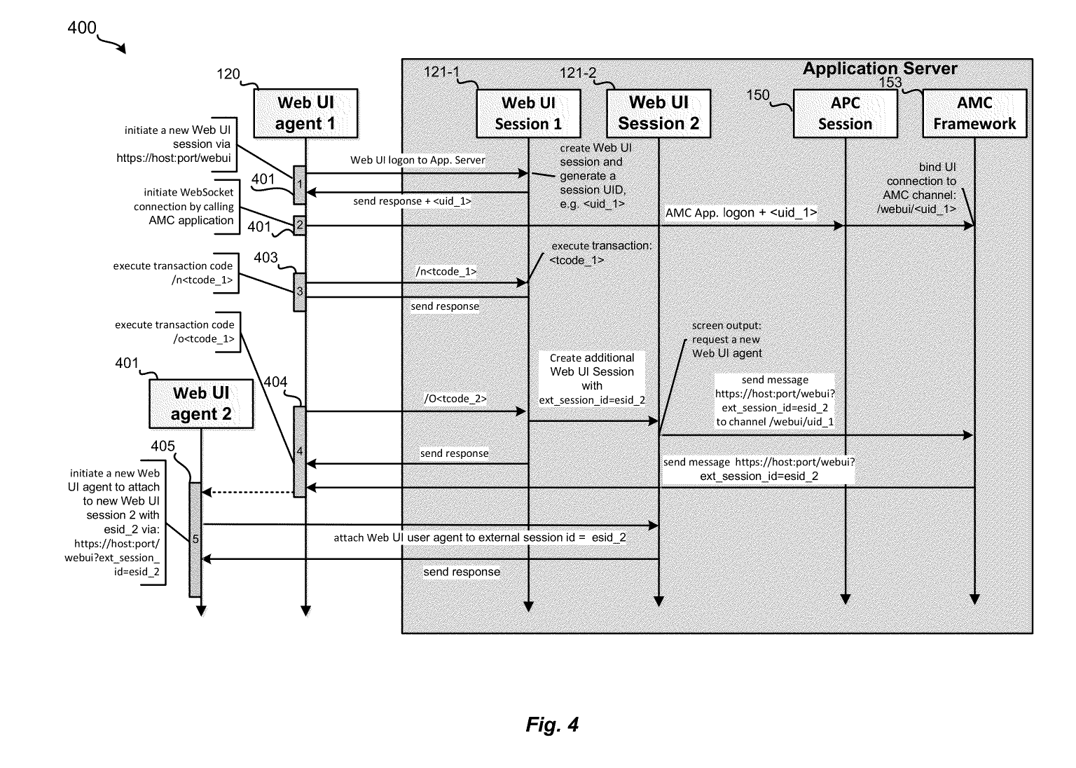

FIG. 4 illustrates a data flow 400 of a method for creating new web UI sessions using AMCs, according to various embodiments of the present disclosure. As shown, at box 401, the web UI agent 120, instantiated in a web browser, may initiate a new web UI session by navigating to a host. This can be achieved by pointing the web browser in which the web UI agent 120 is instantiated to a network address (e.g., https://host:port/webui). The network address may bring the web UI agent to a logon routine for an application server. If authorized, the application server will create a new web UI session 121 and generate a corresponding web UI session ID (e.g., uid_{—}1). The newly instantiated web UI session 121 may then send a response with the web UI session ID back to the web UI agent 120 over the bi-directional UI connection.

At box 402, the web UI agent 120 may bind the bi-directional UI connection (e.g., WebSocket) by calling the APC session 150. Calling the APC session 150 may include sending a logon request to the APC session 150 along with the web UI session ID. In response to the logon request and the web UI session ID, the APC session may bind, or otherwise associate, the bi-directional connection to an AMC dedicated to or associated with the web UI session ID in the AMC framework 153. Once the bi-directional connection is associated with the AMC channel for the web UI session ID, the system is ready to push information about newly created web UI sessions to the web UI agent 120.

At box 403, the web UI agent 121 may request functions that do not require a new web UI session to be created. In some embodiments, these function requests are in the format of “/n<tcode_{—}1>”. In one embodiment, the “n” in the function request indicates that the original web UI session may be used to execute the requested function. In addition, the original web UI agent 120 and corresponding UI may be used to display the results of the web UI session 121-1 executing the request function.

However, in box 404, the web UI agent 120 may request a function that requires the original web UI session 121-1 to create a new web UI session 121-2. In some embodiments, these function requests are in the format of “/o<tcode_{—}2>”. In such embodiments, the “o” in the function request indicates that a new web UI session 121-2 needs to be instantiated to execute the requested function. To instantiate the new web UI session 121-2, the original web UI session 121-1 may create an external session ID (ext_session_id=esid_{—}2). The application server may then create the web UI session 121-2. The web UI session 121-2 may then execute the requested function (e.g., generate a screen output for a new web UI agent 404). The web UI session 121-1 may then send a message that includes its network address in the application server that includes the external session ID (e.g., “https://host:port/webui?_ext_session_id=esid_{—}2”) to the AMC in the AMC framework 153 associated with the original web UI agent 120 (e.g., channel/webui/uid_{—}1). The AMC framework 153 may then push a message with the network address of the new web UI session to the original web UI agent 120 over the bi-directional connection (e.g., WebSocket connection) bound to the AMC associated with the original web UI agent 120. In response to the message with the network address for the new web UI session 121-2, the original web UI agent 120 may initiate a new web UI agent to connect to the new web UI session 121-2 with esid_{—}2 through a connection established over the network connecting the web browser to the application server (e.g., https://host:port/webui?_ext_session_id=esid_{—}2).

At box 405 the new web UI agent can attach to the new web UI session 121-2 by sending a message with the appropriate ID for that session. The new web UI session can then send a response to confirm the attachment, and/or return the response of the requested function.

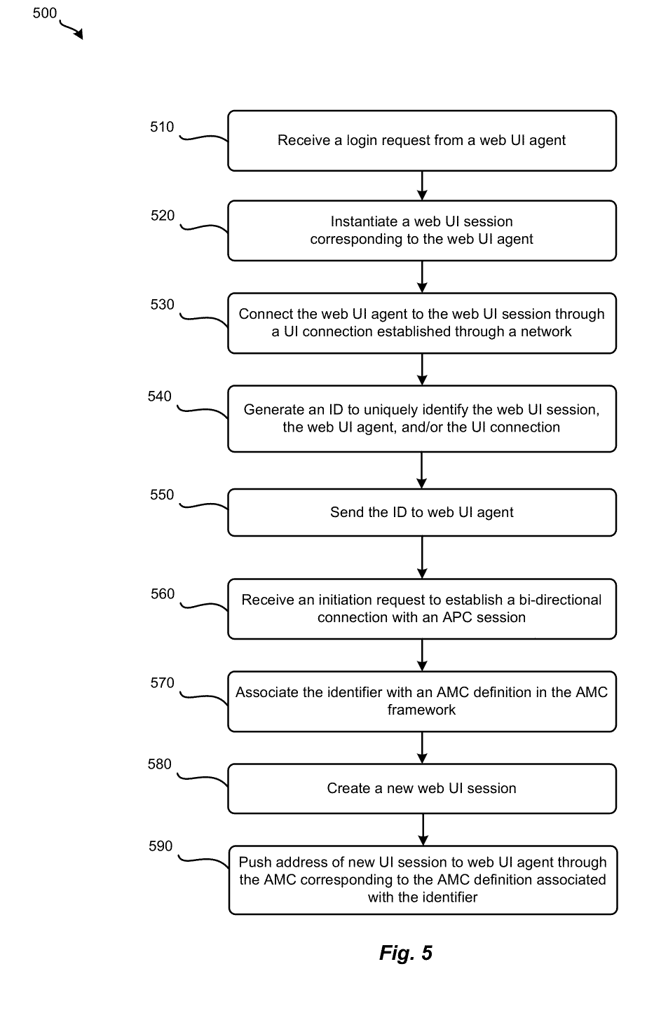

FIG. 5 is a flowchart of a method 500 creating new web UI agents using push channels in an APC session, according to embodiments of the present disclosure. In action 510, a computer system may receive a login request from a web UI agent instantiated in a remote web browser 105. In one embodiment, the computer system may include a DMSS 130 or application server 135.

In action 520, the computer system may instantiate, in the application server or elsewhere, a web UI session corresponding to the web UI agent. The web UI session may handle the execution of functions requested by the web UI agent. The web UI agent may support or display a corresponding UI in the web browser 105.

In action 530, the computer system can connect the web UI agent and the web UI session through a corresponding UI connection established over a network, such as an intranet or the Internet. Accordingly, the UI connection may include a one or more types of TCP/IP transport layer connections or protocols.

In action 540, the computer system may generate an identifier (ID) to uniquely identify the web UI agent, the web UI session, or the UI connection. In action 550, the computer system can send the ID to the web UI agent. The web UI agent can then send, and the computer system may receive, an initiation request to establish a bi-direction (e.g., WebSocket) connection with the APC session, in action 560. This bi-directional connection between the APC session and the web UI agent can be used as a push channel to the web UI agent.

In action 570, the computer system may associate the ID for the web UI agent with one or more AMCs or AMC definitions in the AMC application. Accordingly, the AMC application can push any information from any web UI sessions instantiated in the computer system to the web UI agent through the bi-directional connection by determining an AMC associated with the ID.

In action 580, the computer system may instantiate a new web UI session. The new web UI session may be created in response to user input requesting that a new UI be displayed, or programmatically. The new web UI session may include a network address in the computer system. For example, the new web UI session may be instantiated in an application server having a particular network address.

In action 590, the computer system may push the network address of the new web UI session to the web UI agent through the AMC corresponding to the AMC definition associated with the ID. The web UI agent may then use the network address to create a new web UI agent and connect it to the new web UI session.

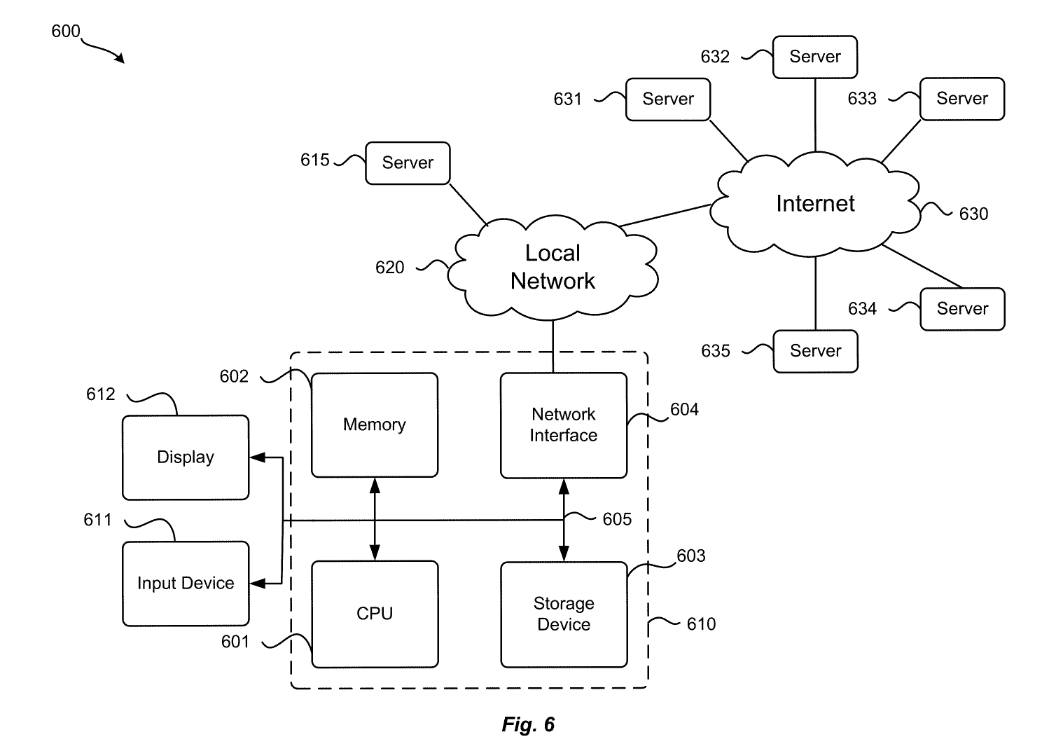

FIG. 6 illustrates an example computer system and networks that may be used to implement embodiments of the present disclosure. Computer system 610 includes a bus 605 or other communication mechanism for communicating information, and a processor 601 coupled with bus 605 for processing information. Computer system 610 also includes a memory 602 coupled to bus 605 for storing information and instructions to be executed by processor 601, including instructions for performing the techniques described above. This memory may also be used for storing temporary variables or other intermediate information during execution of instructions to be executed by processor 601. Possible implementations of this memory may be, but are not limited to, random access memory (RAM), read only memory (ROM), or both. A storage device 603 is also provided for storing information and instructions. The information instructions can be in the form of computer readable code stored on the storage device, accessible and executable by processor to implement various techniques and methods of the present disclosure. Common forms of storage devices include non-transitory, non-volatile computer readable media, for example, a hard drive, a magnetic disk, an optical disk, a CD, a DVD, a flash memory, a USB memory card, or any other medium from which a computer can read.

Computer system 610 may be coupled via the same or different information bus, such as bus 605, to a display 612, touchscreen, or liquid crystal display (LCD), for displaying information. An input device 611 such as a keyboard, touchscreen, and/or mouse is coupled to a bus for communicating information and command selections from the user to processor 601. The combination of these components allows the user to communicate with the system. In some embodiments, the display 612 and the input device 611 may be implemented in a single device, such as a touchscreen.

Computer system 610 also includes a network interface 604 coupled with bus 605. Network interface 604 may provide two-way data communication between computer system 610 and the local network 620. The network interface 604 may be a local area network

(LAN) card to provide a data communication connection to a compatible LAN. The LAN card may include a wireless LAN (WLAN) card for communicating with a corresponding wireless network. In any such implementation, network interface 1004 sends and receives electrical, electromagnetic, or optical signals that carry digital data streams representing various types of information.

The above description illustrates various embodiments of the present disclosure along with examples of how aspects of the present disclosure may be implemented. The above examples and embodiments should not be deemed to be the only embodiments, and are presented to illustrate the flexibility and advantages of the present disclosure as defined by the following claims. Based on the above disclosure and the following claims, other arrangements, embodiments, implementations and equivalents will be evident to those skilled in the art and may be employed without departing from the spirit and scope of the invention as defined by the claims.

1-20. (canceled)

21. A method comprising:
receiving, in a first web UI session instantiated by a computer system, a first function request, wherein the first web UI session is in communication with a first UI agent through a first UI connection established over a network;
determining, by the first web UI session, that the first function request requires a second web UI session to be generated;
generating, by the first web UI session, an external session identifier in response to the determination; and
instantiating, by the computer system, the second web UI session in response to the determination.

22. The method of claim 21, further comprising:
executing, by the second web UI session, the first function request.

23. The method of claim 21, further comprising:
transmitting, by the second web UI session, a network address of the second web UI session and the external session identifier through the first UI connection to the first UI agent.

24. The method of claim 23 wherein transmitting the network address for the second web UI session further comprises sending instructions that cause the first web UI agent to instantiate the second web UI agent in a new web browser window or in a new web browser tab.

25. The method of claim 23, wherein the second UI session generates a second UI agent according to the network address and the external session identifier, wherein the second UI session is configured to connect with the second web UI session.

26. The method of claim 21, further comprising:
receiving, in the second web UI session, a second function request;
executing, by the second web UI session, the second function request to generate a response.

27. The method of claim 21 wherein the first UI connection comprises a bi-directional transport control protocol (TCP).

28. A non-transitory computer readable medium comprising instructions that when executed by a computer processor cause the computer processor to be configured for:
receiving, in a first web UI session instantiated by the computer processor, a first function request, wherein the first web UI session is in communication with a first UI agent through a first UI connection established over a network;
determining, by the first web UI session, that the first function request requires a second web UI session to be generated;
generating, by the first web UI session, an external session identifier in response to the determination; and
instantiating, by the computer processor, the second web UI session in response to the determination.

29. The non-transitory computer readable medium of claim 28, further comprising:
executing, by the second web UI session, the first function request.

30. The non-transitory computer readable medium of claim 28, further comprising:
transmitting, by the second web UI session, a network address of the second web UI session and the external session identifier through the first UI connection to the first UI agent.

31. The non-transitory computer readable medium of claim 30 wherein transmitting the network address for the second web UI session further comprises sending instructions that cause the first web UI agent to instantiate the second web UI agent in a new web browser window or in a new web browser tab.

32. The non-transitory computer readable medium of claim 30, wherein the second UI session generates a second UI agent according to the network address and the external session identifier, wherein the second UI session is configured to connect with the second web UI session.

33. The non-transitory computer readable medium of claim 28, further comprising:
receiving, in the second web UI session, a second function request;
executing, by the second web UI session, the second function request to generate a response.

34. The non-transitory computer readable medium of claim 28 wherein the first UI connection comprises a bi-directional transport control protocol (TCP).

35. A system comprising:
a computer processor; and
a non-transitory computer readable medium comprising instructions that when executed by the computer processor cause the computer processor to be configure to:
receive, in a first web UI session instantiated by the computer processor, a first function request, wherein the first web UI session is in communication with a first UI agent through a first UI connection established over a network;
determine, by the first web UI session, that the first function request requires a second web UI session to be generated;
generate, by the first web UI session, an external session identifier in response to the determination; and
instantiate, by the computer processor, the second web UI session in response to the determination.

36. The system of claim 35, further comprising:
executing, by the second web UI session, the first function request.

37. The system of claim 35, further comprising:
transmitting, by the second web UI session, a network address of the second web UI session and the external session identifier through the first UI connection to the first UI agent.

38. The system of claim 37 wherein transmitting the network address for the second web UI session further comprises sending instructions that cause the first web UI agent to instantiate the second web UI agent in a new web browser window or in a new web browser tab.

39. The system of claim 37, wherein the second UI session generates a second UI agent according to the network address and the external session identifier, wherein the second UI session is configured to connect with the second web UI session.

40. The system of claim 35, further comprising:
receiving, in the second web UI session, a second function request;
executing, by the second web UI session, the second function request to generate a response.
